(19) United States
(12) Patent Application Publication
(10) Pub. No.: US 2016/0028622 A1
(43) Pub. Date: Jan. 28, 2016

(54) NETWORK PATH SETUP METHOD BASED ON IDENTIFIER, AND APPARATUS THEREOF

(71) Applicant: ELECTRONICS AND TELECOMMUNICATIONS RESEARCH INSTITUTE, Daejeon (KR)

(72) Inventors: Byeong-Ok KWAK, Daejeon (KR); Woo-Jik CHUN, Seoul (KR)

(21) Appl. No.: 14/803,256

(22) Filed: Jul. 20, 2015

(30) Foreign Application Priority Data
Jul. 22, 2014 (KR) 10-2014-0092732

(51) Int. Cl. H04L 12/741; H04L 29/12; H04L 29/06

(52) U.S. Cl. CPC H04L 45/54; H04L 29/0653; H04L 61/6022; H04L 69/22; H04L 45/74

(57) ABSTRACT

Exemplary embodiments of the present invention relate to a network path setup method based on identifier and apparatus thereof. A network path setup method in a repeater equipment, the method comprising: receiving a packet; determining whether source/destination node identifiers included in the received packet are stored in a routing table; and updating the routing table based on a node identifier and a port number which is used for packet transmission to the node when it is determined as that the node identifier is not stored. According to exemplary embodiments of the present invention, it simplifies a routing table to quickly search packet paths and reduces traffics since it does not require to define an additional header.

### CROSS REFERENCE TO RELATED APPLICATION

This application claims the benefit of Korean Patent Application No. 10-2014-0092732, filed on Jul. 22, 2014, entitled “Network path setup method based on identifier and apparatus thereof”, which is hereby incorporated by reference in its entirety into this application.

### BACKGROUND

1. Technical Field

Exemplary embodiments of the present invention relate to a network path setup method based on identifiers and an apparatus thereof.

2. Description of the Related Art

Networks are constructed using local area network (LAN) switches, routers or the like in small-scale network environment such as campus network or campus area network (CAN) or building network. When networks are constructed using routers, networks using IPv4 (Internet Protocol version 4) and IPv6 (Internet Protocol version 6), etc. may include a plurality of sub-networks and each sub-network has a unique prefix. Therefore, a node belonged to a plurality of sub-networks has a plurality of IP addresses and each interface has one address. When an interface is moved from a sub-network to another sub-network, it means that its IP address has to be changed. In this case, management is required by an IP network manager and such an IP network management can be complicated since an IP router should setup a sub-network address for each port.

When networks are constructed using just LAN switches without routers, even though a node is moved from one to another, the same IP address can be used without changing. However, when networks are constructed using just LAN switches, transmission path cannot be optimized due to a spanning tree algorithm operating inside the LAN switches and a dual path provided through connection between LAN switches cannot be used.

Rbridge technology has been developed in order to resolve such problems. Rbridge technology combines LAN switching techniques which provide network connections in plug & play types without managing IP addresses and routing techniques which provide packet transmissions through optimal paths and traffic distribution through dual paths.

Rbridge technology uses a routing protocol similar to Intermediate System to Intermediate System (IS-IS) rather than the spanning tree algorithm, which is an algorithm to logically cut off loops formed between switches. Here, the routing algorithm similar to the IS-IS may function differently from that of a routing algorithm in a conventional router since it is to obtain connection information between LAN switches.

FIG. 1 illustrates a campus network constructed with Rbridges.

The campus network shown in FIG. 1 is constructed with one IP sub-network for the entire campus. Rbridge obtains mapping information between IP addresses of nodes in ethernet which are managed by itself and MAC (Media Access Control) addresses through “self-learning” like conventional LAN switches, and shares information by transmitting to another Rbridge. The other operations are identical to the LAN switch. Rbridge technology constructs with one sub-network for the entire network. When Rbridge receives an address resolution protocol (APR) request message which is transmitted from a source node, the Rbridge searches its own mapping database. When the Rbridge knows the MAC address of the destination node, it transmits a response message to the source node based on the searched information. On the other hand, when the Rbridge does not know the MAC address of the destination node, it requests the MAC address of the destination node to all Rbridges through paths between Rbridges formed by the IS-IS routing protocol. When the source node generates and transmits a LAN frame to the destination node, the Rbridge connected to the source node receives it and transmits the received LAN frame to a destination Rbridge based on its database information. The LAN frame transmitted to the destination Rbridge is transmitted to the destination node.

The Rbridge technology has a drawback associated with huge volume of data (IP address/MAC address mapping table and path table to each Rbridge, etc.) to be managed by Rbridges.

Furthermore, the Rbridge technology should define a packet header separately to be operated in the environment where the conventional routers or switches are commonly existing. Thus, it causes increase in data traffics associated with defining additional packet header and also requires an interface needed for processing the additional packet header.

### SUMMARY

Exemplary embodiments of the present invention provide a plan for simplifying database and fast transmitting and receiving packets.

A network path setup method in a repeater equipment according to an embodiment of the present invention comprises: receiving a packet; determining whether source/destination node identifiers included in the received packet are stored in a routing table; and updating the routing table based on a node identifier and a port number which is used for packet transmission to the node when it is determined as that the node identifier is not stored.

A network path setup apparatus in a repeater equipment according to an embodiment of the present invention comprises: a control unit configured to determine whether source/destination node identifiers included in a received packet are stored in a routing table when the packet is received; and a routing table managing unit configured to store a routing table and update the routing table based on a node identifier and a port number which is used for packet transmission to the node when it is determined as that the node identifier is not stored.

According to exemplary embodiments of the present invention, it simplifies a routing table to quickly search packet paths and reduces traffics since it does not require to define an additional header.

### BRIEF DESCRIPTION OF DRAWING

FIG. 1 illustrates a campus network constructed with Rbridge.

FIG. 2A, FIG. 2B and FIG. 2C illustrate network environments in which exemplary embodiments of the present invention are applied.

FIG. 3 is a flowchart illustrating a network path setup method according to an embodiment of the present invention.

FIG. 4 is a flowchart illustrating a network path setup method according to an embodiment of the present invention when source/destination nodes are in the same domain.

FIG. 5A, FIG. 5B and FIG. 5C are a flowchart illustrating a network path setup method according to an embodiment of the present invention when source/destination nodes are in different domains.

FIG. 6 is a block view illustrating a network path setup apparatus in a repeater equipment according to an embodiment of the present invention.

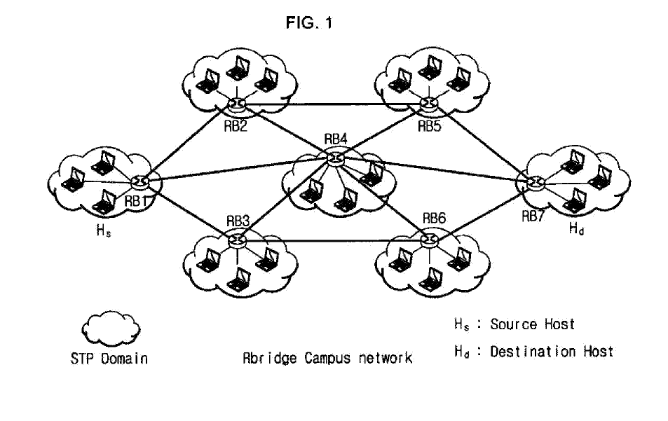

### DESCRIPTION OF THE EXEMPLARY EMBODIMENTS

Throughout the description of the present invention, when describing a certain technology is determined to evade the point of the present invention, the pertinent detailed description will be omitted.

As described above, database may become huge by having all information of all nodes in networks in the Rbridge technology which has been conventionally used. In addition, the Rbridge technology which has been conventionally used requires an interface to process an additional header which thus causes traffic increase due to requiring for defining the additional packet header.

Accordingly, exemplary embodiments of the present invention provide a network system which is able to simplify database and preform fast packet transmitting/receiving.

Exemplary embodiments of the present invention transmit packets based on a global network topology and store information related to transmitting/receiving paths when packets are transmitted/received. Exemplary embodiments of the present invention do not store unnecessary information among information related to each component which is composed to configure the entire network topology.

Hereinafter, exemplary embodiments of the present invention will be described with reference to the accompanying drawings.

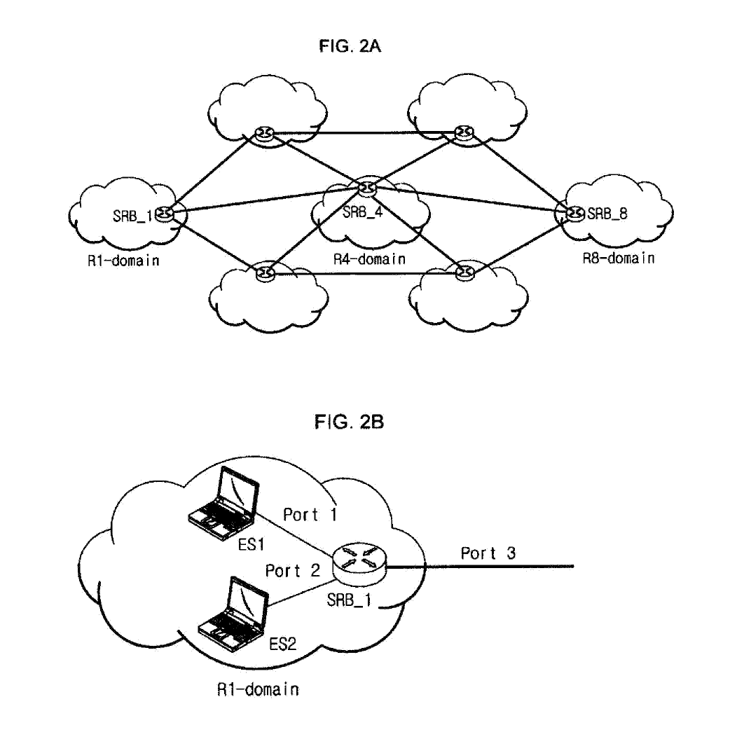

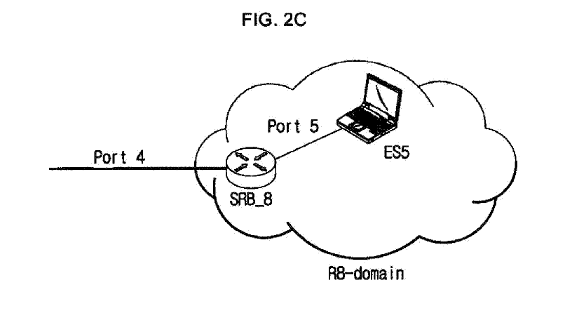

Network environments in which exemplary embodiments of the present invention are applied will be explained with reference to FIG. 2A, FIG. 2B and FIG. 2C.

Exemplary embodiments of the present invention may be applied in a campus network as shown in FIG. 2A. The campus network may include at least one SRB (Signal based RBridge) and at least one ES (End System).

The SRB according to an embodiment of the present invention may be an interface which combines switching technique to the conventionally used Rbridge technique. The SRB may construct a network topology and further construct a routing table based on the constructed network topology.

The network topology may be constructed using various methods. For example, the network topology may be constructed using a IS-IS routing protocol.

When a packet is received from an ES, the SRB according to an embodiment of the present invention may construct a routing table by obtaining information related to the ES which transmitted the packet and the ES which is to receive the packet, rather than storing information related to all ESs existing in the network to construct a routing table. The SRB according to an embodiment of the present invention may not perform self-leaning for child nodes when there is no packet transmission, while the other operations are the same as the conventional Rbridge.

The ES is belonged to the domain which each SRB manages in an ethernet environment and may transmit packets to the SRB or receive packets from the SRB. The domain may be a spanning tree protocol (STP) domain.

As shown in FIG. 2B, it is assumed that two nodes (ES_1 , ES_2) are in a domain(R1) which SRB_1 manages and ES_1 is connected to a port 1 of SRB_1 and ES_2 is connected to a port 2 of SRB_1. It is also assumed that an optimal path from SRB_1 to SRB_8 using the IS-IS routing protocol is determined as a path through SRB_4.

As shown in FIG. 2C, it is assumed that one node (ES_5) is in a domain (R8) which SRB_8 manages and ES_5 is connected to a port 5 of SRB_8.

When a packet is transmitted from the source node ES_1 to the SRB_1 in these network conditions, a network path setup method will be explained with reference to accompanying drawings.

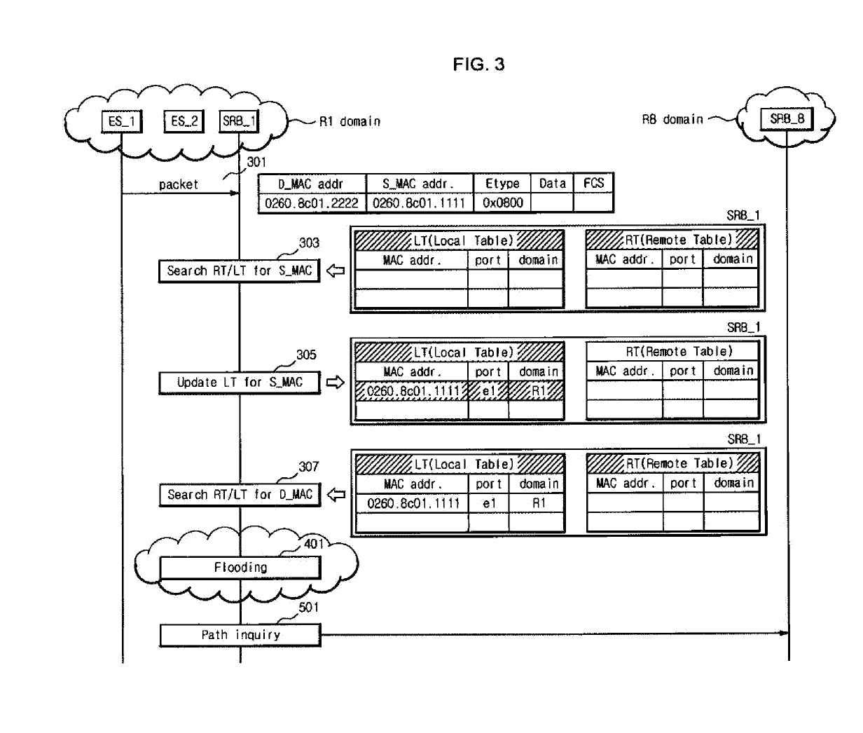

FIG. 3 is a flowchart illustrating a network path setup method according to an embodiment of the present invention.

In S301, a SRB _1 receives a packet from a source node, which is an ES_1. The received packet may include a source/destination node identifier. Throughout the description of the present invention, it is assumed that the source/destination node identifier is a MAC address of a node. It is also assumed that the source node MAC address included in the received packet is ‘0260.8c01.1111’ and the destination node MAC address is ‘0260.8c01.2222’.

The SRB_1 determines whether source/destination node identifiers included in the received packet are stored in a routing table and updates the routing table based on the node identifier and a port number which is used for packet transmission to the node when the node identifier is not stored.

In an embodiment, the routing table may be divided into a local table and a remote table. Here, the local table may store source node identifiers included in the packet received from a domain (R1; referred to as internal domain) which the SRB_1 manages, and a port number to which the packet is received. The remote table may store source node identifiers included in the packet received from a SRB_X which manages the rest domains (hereinafter, external domain), except the internal domain and a port number to which the packet is received.

Hereinafter, exemplary embodiments of the present invention will be explained by assuming that a routing table includes a local table and a remote table.

In S303, the SRB_1 determines whether the source node MAC address included in the received packet is stored in the remote table and the local table and proceeds to S305 when the source node MAC address is not stored in the remote table and the local table.

In an embodiment, when it is determined whether the source node MAC address is stored or not, the SRB_1 may search first the local table and then the remote table when it is not stored in the local table.

As described above, in exemplary embodiments of the present invention, since the SRB does not perform self-learning for child nodes if transmitting/receiving packets is not made, if the received packet is the first packet from the ES_1, the MAC address of the ES_1 is not stored in the remote table and the local table. Thus, it may proceed to S305.

In S305, the SRB_1 matches the source node MAC address with a port number (e1) to which the packet is received to store in the local table. Each SRB may recognize whether the packet is received through the port connected with an external domain or received through the port connected with an internal domain. When the packet is received through the port number (e1) connected with an internal domain, the SRB_1 may store the source node MAC address, which transmitted the packet, in the local table. Here, the SRB_1 may also store a domain (R1) to which the ES_1, which is the source node transmitting the received packet, belong. Domain information of the node which transmitted the packet may be included in a packet header. Thus, the SRB_1 may analyze the packet header to store the domain of the source node, which transmitted the packet, in the local table. The stored domain information may be used to determine whether the packet forwards to a node belonged to the internal domain or forwards to a node belonged to the external domain. When the packet forwards to a node belonged to the internal domain, the SRB may control the packet not to broadcast towards outside.

In S307, the SRB_1 may determine whether a destination node MAC address included in the received packet is stored in the remote table and the local table to obtain a path to the destination node. In an embodiment, when it is determined whether the destination node MAC address is stored or not, the SRB_1 may first search the remote table and then search the local table when it is not searched in the remote table.

When the destination node MAC address is not stored in the remote table and the local table, the SRB_1 may proceed to S401, S501 to obtain a path to the destination node since it does not know whether the destination node is located in the internal domain or the external domain.

In S401, the SRB_1 may flood the received packet in the internal domain.

In S501, the SRB_1 may generate a path inquiry message including the received packet and transmit the path inquiry message to the SRBs which manage each external domain through a control path. The control path may be formed according to a routing path between domains. When a plurality of SRBs are in each domain, the control path may be a path between representative SRBs representing domains. The control path may have a forwarding cache to forward data in a data plane.

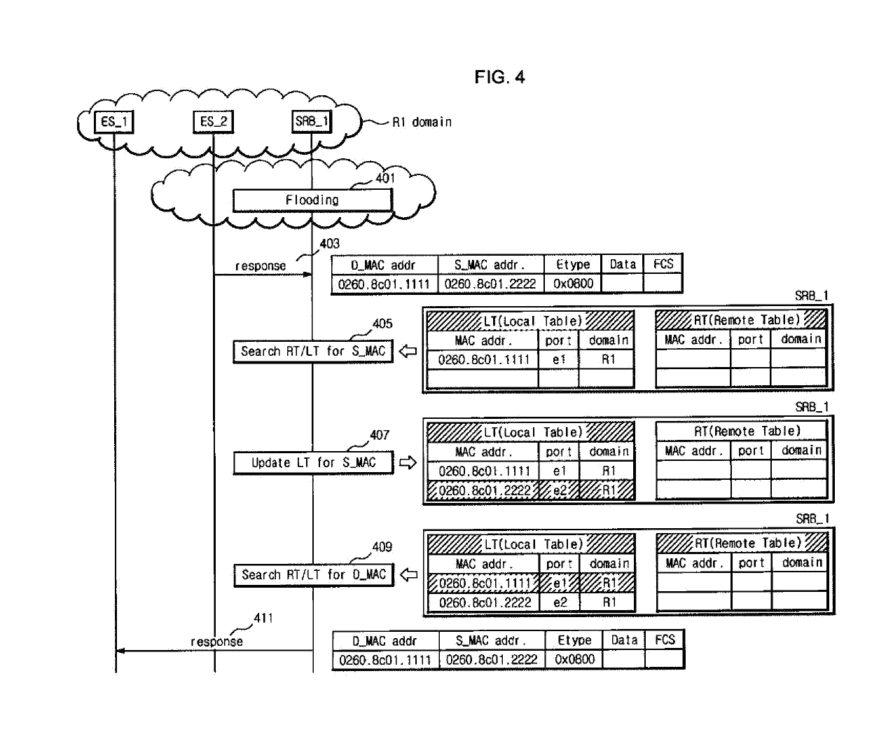

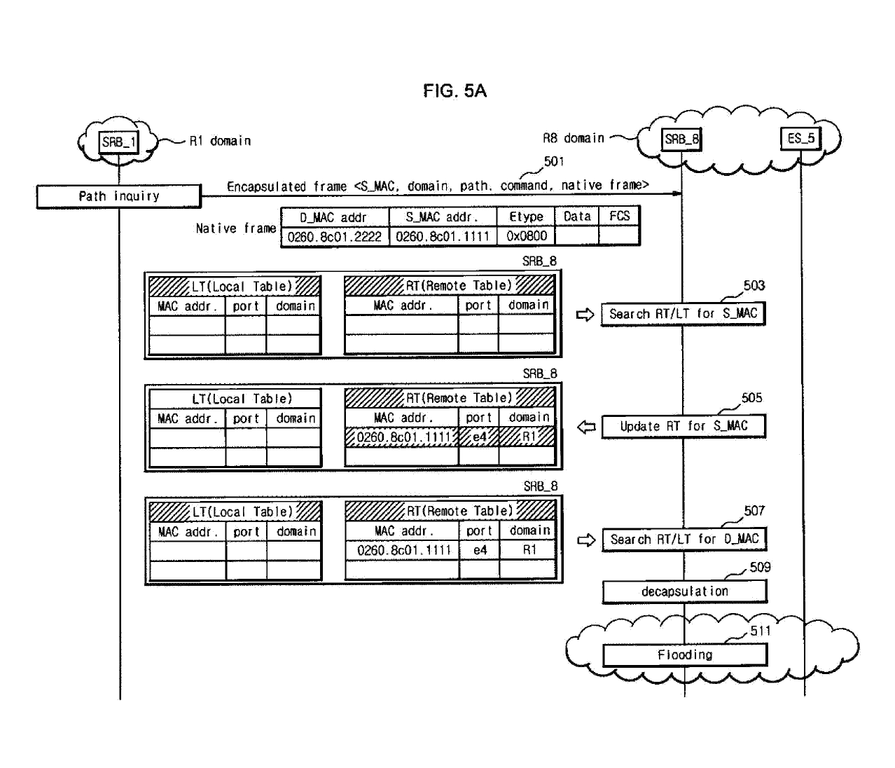

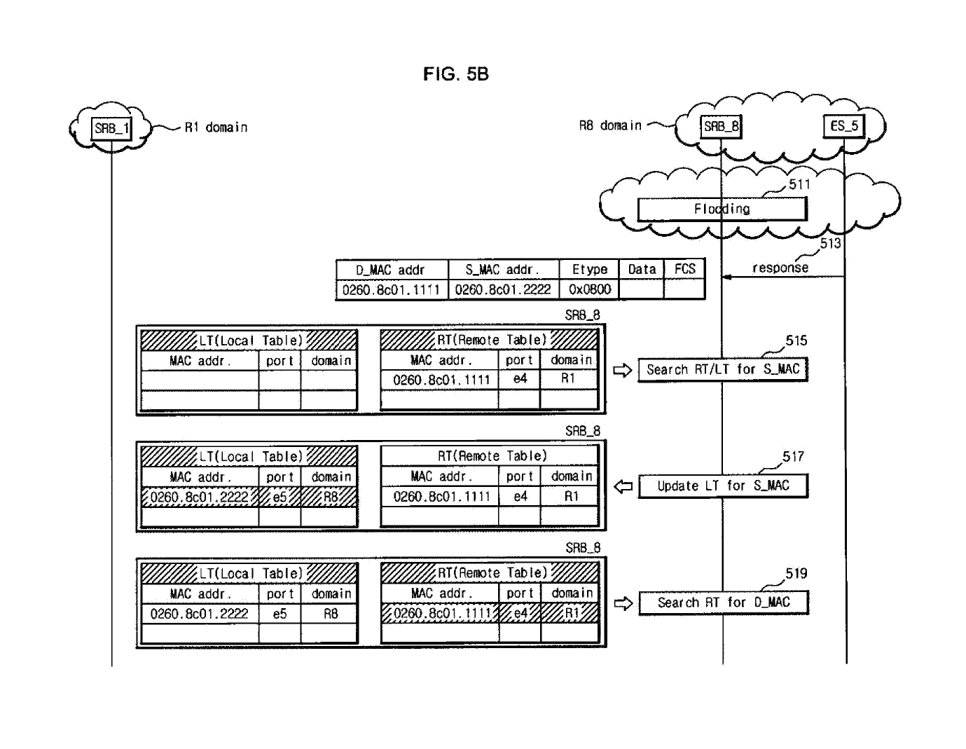

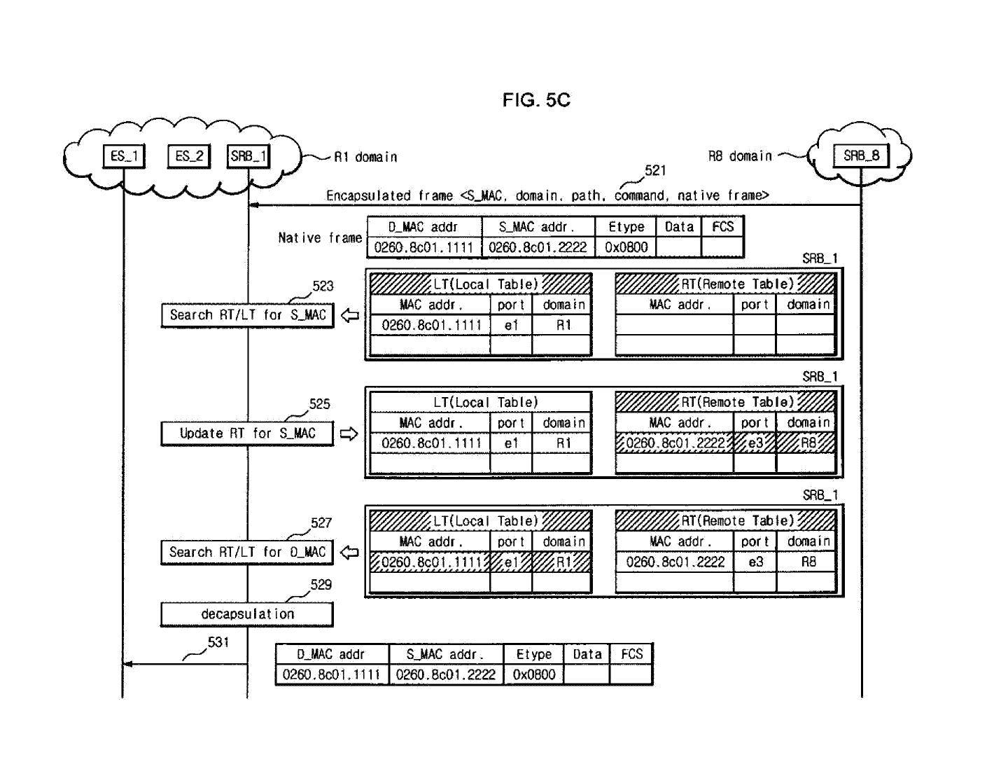

Next steps will be explained with reference to FIG. 4, FIG. 5A, FIG. 5B and FIG. 5C.

FIG. 4 is a flowchart illustrating a network path setup method according to an embodiment of the present invention when source/destination nodes are in the same domain.

Steps in FIG. 4 are continued from the steps shown in FIG. 3.

In S401, when the SRB_1 floods the received packet to the internal domain, the ESs belonged to the internal domain may receive the flooded packet. The ES corresponding to the destination node MAC address included in the flooded packet may generate a response packet to transmit to the SRB_1. In an embodiment described with reference to FIG. 4, it is assumed that the ES corresponding to the destination node MAC address of the flooded packet is ES_2.

In S403, the SRB_1 may receive the response packet from the ES_2. The response packet may have MAC addresses opposite to the received packet. The source node MAC address of the response packet is identical to the destination node MAC address of the received packet and the destination node MAC address of the response packet is identical to the source node MAC address of the received packet.

In S405, the SRB_1 may determine whether the source node MAC address included in response packet is stored in the remote table and the local table. In an embodiment, when it is determined whether the source node MAC address is stored or not, the SRB_1 may first search the local table and then search the remote table when it is not searched in the local table. When the first packet is transmitted from the ES_2, the source node MAC address of the response packet may not be stored in the remote table and the local table. In this case, the SRB_1 proceeds to S407.

In S407, the SRB_1 may store the source node MAC address of the response packet and a port number, to which the response packet is received, in the local table. Here, the SRB_1 may store a domain (R1) to which the source node, which is the ES_2 transmitting the response packet, belong.

In S409, the SRB_1 may determine whether the destination node MAC address included in the response packet is stored in the remote table and the local table in order to obtain a path to the destination node. When it is stored, it may proceed to S411.

In an embodiment, when it is determined whether the destination node MAC address is stored or not, the SRB_1 may first search the remote table and then search the local table when it is not searched in the remote table. The destination node MAC address included in the response packet may be identical to the source node MAC address included in the received packet, and the source node MAC address included in the received packet is stored in S305 of FIG. 3 and thus, it proceeds to S411.

In S411, the SRB_1 may transmit the response packet by referring to the local table. That is, the SRB_1 may transmit the response packet by referring to the port number in the local table stored by being corresponded to the destination node MAC address included in the response packet. It means that the response packet is outputted to the port corresponding to the port number.

FIG. 5A, FIG. 5B and FIG. 5C are flowchart illustrating a network path setup method according to an embodiment of the present invention when source/destination nodes are in different domains.

The steps illustrated in FIG. 5A, FIG. 5B and FIG. 5C are continued from the steps in FIG. 3. In the description with reference to FIG. 5A, FIG. 5B and FIG. 5C, operation of SRB_8 will be explained under assumption that a destination node is in R8 among the external domains. The following operations may be performed in the SRBs which manage other external domains in addition to R8.

In S501, when the SRB_1 transmits a path inquiry message, the SRB_8 may receive the path inquiry message through a control path. Here, it is assumed that the path inquiry message is received through an optimal path based on a routing protocol, for example, through R4. The path inquiry message may be an encapsulated frame and may include at least one chosen from a source node MAC address, a domain, a path, a command and a native frame (the received packet).

In S503, the SRB_8 may decode the received path inquiry message and determine whether the source node MAC address included in the received packet is stored in the remote table and the local table. In an embodiment, when it is determined whether the source node MAC address is stored or not, the SRB_8 may first search the local table and then search the remote table when it is not searched in the local table. The remote table and the local table may be managed for each SRB. Therefore, the remote table and the local table used in S503 may be different from that for the SRB_1. When the source node MAC address included in the received packet is not stored in the remote table and the local table, it may proceed to S505.

In S505, the SRB_8 may store the source node MAC address included in the received packet and a port number, to which the path inquiry message is received, in the remote table.

In S507, the SRB_8 may determine whether the destination node MAC address included in the received packet is stored in the remote table and the local table and proceed to S509 when it is not stored. In an embodiment, when it is determined whether the destination node MAC address is stored or not, the SRB_8 may first search the remote table and then search the local table when it is not searched in the remote table.

In S509, the SRB_8 may decapsulate the path inquiry message and proceed to S511 to flood the received packet included in the path inquiry message in a domain (R8) which is managed by itself.

In S513, the ESs in the domain (R8) may receive the flooded packet from the SRB_8. The ES corresponding to the destination node MAC address included in the flooded packet may generate a response packet to transmit to the SRB_8. It is assumed that the ES corresponding to the destination node MAC address included in the flooded packet is ES_5 in an embodiment described with reference to FIG. 5A, FIG. 5B and FIG. 5C. On the other hand, the response packet may have MAC addresses opposite to the received packet. The source node MAC address of the response packet is identical to the destination node MAC address of the received packet and the destination node MAC address of the response packet is identical to the source node MAC address of the received packet.

In S515, the SRB_8 may determine whether the source node MAC address included in the response packet is stored in the local table and the remote table. In an embodiment, when it is determined whether the source node MAC address is stored or not, the SRB_8 may first search the local table and then search the remote table when it is not searched in the local table. When the first packet is transmitted from the ES_5, the source node MAC address of the response packet may not be stored in the remote table and the local table. In this case, it may proceed to S517.

In S517, the SRB_8 may store the source node MAC address included in the response packet and a port number, to which the response packet is received, in the local table.

In S519, the SRB_8 may determine whether the destination node MAC address included in the response packet is stored in the remote table and the local table and proceed to S521 when it is stored. In an embodiment, when it is determined whether the destination node MAC address is stored or not, the SRB_8 may first search the remote table and then search the local table when it is not searched in the remote table. The destination node MAC address included in the response packet may be identical to the source node MAC address included in the received packet and the source node MAC address included in the received packet is stored in S505 and thus, it proceeds to S521. Since the source node MAC address is searched in the remote table in S519, it may not search the local table.

In S521, the SRB_8 may generate a route response message including the response packet to transmit to the SRB_1. The route response message may include at least one chosen from a source node MAC address, a domain, a path, a command and a native frame (response packet).

In S523, the SRB_1 may decode the route response message and determine whether the source node MAC address included in the response packet is stored in the remote table and the local table. In an embodiment, when it is determined whether the source node MAC address is stored or not, the SRB_1 may first search the local table and then search the remote table when it is not searched in the local table. Since the response packet is the first packet received from the ES_5, MAC addresses of the ES_5 may not be stored. Thus, the SRB_1 may proceed to S525.

In S525, the SRB_1 may store the source node MAC address included in the response packet and a port number, to which the route response message is received, in the remote table.

In S527, the SRB_1 may determine whether the destination node MAC address included in the response packet is stored in the remote table and the local table and proceed to S529 when it is stored. In an embodiment, when it is determined whether the destination node MAC address is stored or not, the SRB_1 may first search the remote table and then search the local table when it is not searched in the remote table. The destination node MAC address included in the response packet may be identical to the source node MAC address included in the received packet and since 10 the source node MAC address included in the received packet is stored in S305 in FIG. 3, it may proceed to S529.

In S529, the SRB_1 may decapsulate a route response message and proceed to S531 to transmit the response packet to the ES_1.

It is described that when the destination node MAC address is searched, the remote table is first searched and the destination node MAC address is then searched in the local table when it is not stored in the remote table in the description described with reference to FIG. 3, FIG. 4, FIG. 5A, FIG. 5B and FIG. 5C. On the contrary to this, when the destination node MAC address is searched, the local table may be first searched and the remote table is then searched when the destination node MAC address is not stored in the local table. It may be the same when the source node MAC address is searched. As described above, when the MAC address is searched in one of the remote table and the local table, a search process in the other table may be omitted.

Forwarding cache may be generated through the steps described with reference to FIG. 2A, FIG. 2B, FIG. 2C, FIG. 3, FIG. 4, FIG. 5A, FIG. 5B and FIG. 5C and packets may be transmitted through the generated forwarding cache.

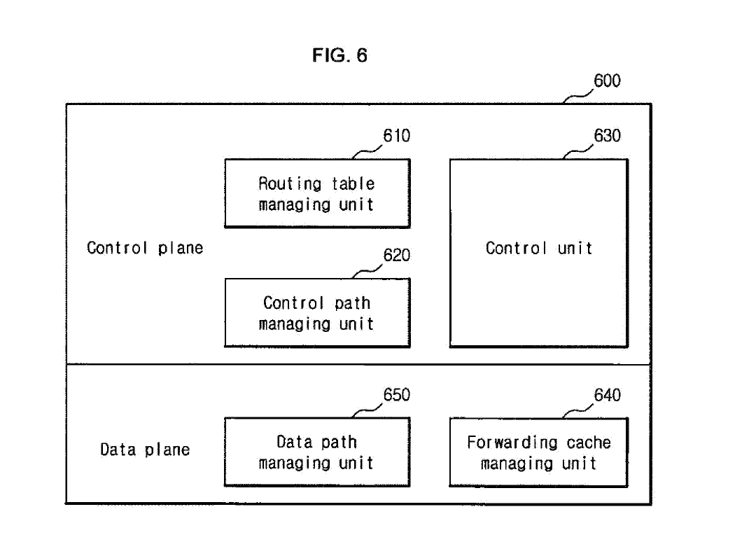

FIG. 6 is a block view illustrating a network path setup apparatus in a repeater equipment according to an embodiment of the present invention.

Referring to FIG. 6, a network path setup apparatus according to an embodiment of the present invention may include a routing table managing unit 610, a control path managing unit 620, a control unit 630, a forwarding cache managing unit 640 and a data path managing unit 650. According to an embodiment, at least one component thereof may be omitted.

The routing table managing unit 610 may construct a topology for the entire network based on link state information between nodes. The topology may be constructed using various routing protocols. For example, the topology may be constructed using the IS-IS routing protocol.

The routing table managing unit 610 may manage routing information between nodes based on the constructed topology. The routing table managing unit 610 may store information about the nodes within the domain (e.g., STP domain in the ethernet environment), which the SRB manages, in the local table and Information about the nodes of the external domain in the remote table.

When there is a node identifier which is not stored in a routing table among source/destination node identifiers included in the packet received from the internal domain or the external domain, the routing table managing unit 610 may update the routing table based on the node identifier and a port number which is used for packet transmission to the node. For example, when a source node identifier included in the received packet is not stored in the routing table, the routing table managing unit 610 may update the routing table based on the source node identifier included in the received packet and a port number to which the packet is received.

In an embodiment, when a source node and a destination node are belonged to the same domain, the routing table managing unit 610 may update the routing table based on the source node identifier included in the response packet received from ES by corresponding to the received packet flooded in the internal domain and the port number to which the response packet is received. The flooding may be performed by the control unit 630 when it is determined as that the destination node identifier included in the received packet is not stored in the routing table. A response packet may be transmitted based on the updated routing table and the destination node identifier included in the response packet. This transmission may be made by the control unit 630.

In an embodiment, when a source node and a destination node are belonged to a different domain from each other, the routing table managing unit 610 may update the routing table based on the source node identifier included in the route response message received from another SRB which manages another domain and a port number to which the route response message is received. The route response message may be a response message for a path inquiry message which is generated by the control unit 630 to transmit to another SRB when it is determined as that the destination node identifier included in the received packet is not stored in the routing table. The route response message may be a message including the response packet received from a destination node which belongs to the other domain, corresponding to the received packet flooded in the other domain which the other SRB manages. A response packet may be transmitted based on the updated routing table and the destination node identifier included in the route response message. This transmission may be made by the control unit 630.

The control path managing unit 620 may manage a control path between SRBs based on the routing information and link state information between SRBs. The link state information may include information about route cost between adjacent SRBs. The information about route cost may include at least one of neighboring domain information, connection state (on/off), link type, bandwidth and cost.

The control unit 630 may manage information of nodes belonged to a domain which the SRB manages. The information about nodes may include at least one of addresses, connection interfaces and connection states of the nodes belonged to the domain. The control unit 630 may also control for smooth routing by performing path inquiry and path setup. When there is no information about a destination node in the local table or the remote table, the path inquiry may include flooding a control packet in the network to find the destination node. The path setup may include: a process for determining by a representative SRB, which is belonged to the domain which the flooded control packet is received, whether there is a destination node in a domain which the representative SRB manages according to the control packet; and a process for storing path information in the process for transmitting a response message from the destination node in a forwarding cache when destination node is determined according to the process. Packets may be transmitted through optimal transmission paths between nodes based on the path inquiry and the path setup. When a packet is received, the control unit 630 may determine whether source/destination node identifiers included in the received packet are stored in a routing table or not and may control the routing table managing unit 610 based on the determined result or output the determined result to the routing table managing unit 610.

When it is determined as that a destination node identifier of the packet is stored in a routing table, the control unit 630 may transmit the packet based on the routing table and the destination node identifier included in the packet.

The forwarding cache managing unit 640 may store and manage the path information setup by the control unit 630. The forwarding cache managing unit 640 may store and manage a forwarding cache during transmitting/receiving the packet (including a path inquiry message and a route response message). The forwarding cache managing unit 640 may update periodically to eliminate forwarding caches which are not used so that it may avoid unnecessary information search.

The data path managing unit 650 may transmit packets between the same nodes based on the forwarding cache without any additional control process.

The exemplary embodiment of the present invention can be implemented by various method. For example, the exemplary embodiment of the present invention can be implemented by using hardware, software or its combination. When they are implemented by software, they may be implemented as software executing in more than one processors using various operating systems or platforms. In addition, the software may be created by using any language among various appropriate programming languages or be compiled in machine language codes or intermediate codes executable in a framework or virtual machine.

In addition, when the exemplary embodiment of the present invention is executed in more than one processors, the exemplary embodiment of the present invention may be implemented by processor readable media such as a memory, a floppy disk, a hard disk, a compact disk (CD), an optical disk or a magnetic tape, or the like in which more than one programs are recorded to conduct the implementation of various exemplary embodiments of the present invention.

What is claimed is:

1. A network path setup method in a repeater equipment, the method comprising:
receiving a packet;
determining whether source/destination node identifiers included in the received packet are stored in a routing table; and
updating the routing table based on a node identifier and a port, number which is used for packet transmission to the node when it is determined as that the node identifier is not stored.

2. The network path setup method of claim 1, wherein the updating the routing table comprises updating the routing table based on a source node identifier included in the received packet and a port number to which the packet is received when the source node identifier included in the received packet is not stored.

3. The network path setup method of claim 1, wherein the updating the routing table comprises:
flooding the received packet in a domain which the repeater equipment manages when the destination node identifier included in the received packet is not stored; and
receiving a response packet from a destination node included in the domain and updating the routing table based on a source node identifier included in the response packet and a port number to which the response packet is received.

4. The network path setup method of claim 3, further comprising transmitting the response packet based on the updated routing table and the destination node identifier included in the response packet.

5. The network path setup method of claim 2, wherein the updating the routing table comprises:
generating a path inquiry message including the received packet to transmit to another repeater equipment which manages another domain when the destination node identifier included in the received packet is not stored; and
receiving a route response message from the another repeater equipment and updating the routing table based on the source node identifier included in the route response message and a port number to which the route response message is received.

6. The network path setup method of claim 5, wherein the route response message is a message comprising a response packet received from the destination node included in the other domain in correspondence with the received packet flooded in the another domain which the another repeater equipment manages.

7. The network path setup method of claim 6, further comprising transmitting the response packet based on the updated routing table and the destination node identifier included in the route response message.

8. The network path setup method of claim 1, further comprising transmitting the received packet based on the routing table and the destination node identifier included in the received packet when it is determined as that the destination node identifier is stored.

9. The network path setup method of claim 1, wherein the routing table comprises:
a local table configured to store the source node identifier of the packet received from the domain which the repeater equipment manages and a port number to which the packet is received; and
a remote table configured to store the source node identifier of the packet received from another repeater equipment which manages another domain and a port number to which the packet is received.

10. The network path setup method of claim 1, wherein the identifier is a media access control (MAC) address of a corresponding node.

11. A network path setup apparatus in a repeater equipment comprising:
a control unit configured to determine whether source/destination node identifiers included in a received packet are stored in a routing table when the packet is received; and
a routing table managing unit configured to store a routing table and update the routing table based on a node identifier and a port number which is used for packet transmission to the node when it is determined as that the node identifier is not stored.

12. The network path setup apparatus of claim 11, wherein the routing table managing unit updates the routing table based on a source node identifier included in the received packet and a port number to which the packet is received when the source node identifier included in the received packet is not stored.

13. The network path setup apparatus of claim 12, wherein the control unit floods the received packet in a domain which the repeater equipment manages when the destination node identifier included in the received packet is not stored to receive a response packet from a destination node included in the domain, and
the routing table managing unit updates the routing table based on a source node identifier included in the response packet and a port number to which the response packet is received.

14. The network path setup apparatus of claim 13, wherein the control unit transmits the response packet based on the updated routing table and the destination node identifier included in the response packet.

15. The network path setup apparatus of claim 12, wherein the control unit generates a path inquiry message including the received packet to transmit to another repeater equipment which manages another domain when the destination node identifier included in the received packet is not stored and receives a route response message from the another repeater equipment, and
the routing table managing unit updates the routing table based on the source node identifier included in the route response message and a port number to which the route response message is received.

16. The network path setup apparatus of claim 15, wherein the route response message is a message comprising a response packet received from the destination node included in the other domain in correspondence with the received packet flooded in the another domain which the another repeater equipment manages.

17. The network path setup apparatus of claim 16, wherein the control unit transmits the response packet based on the updated routing table and the destination node identifier included in the route response message.

18. The network path setup apparatus of claim 11, wherein the control unit transmits the received packet based on the routing table and the destination node identifier included in the received packet when it is determined as that the destination node identifier is stored.

19. The network path setup apparatus of claim 11, wherein the routing table comprises:
a local table configured to store the source node identifier of the packet received from the domain which the repeater equipment manages and a port number to which the packet is received; and
a remote table configured to store the source node identifier of the packet received from another repeater equipment which manages another domain and a port number to which the packet is received.

20. The network path setup apparatus of claim 11, wherein the identifier is a media access control (MAC) address of a corresponding node.
